(19) United States
(12) Patent Application Publication
(10) Pub. No.: US 2014/0043841 A1
(43) Pub. Date: Feb. 13, 2014

(54) VEHICULAR ILLUMINATION LAMP

(71) Applicant: Koito Manufacturing Co., Ltd., Tokyo (JP)

(72) Inventor: Naoki Uchida, Shizuoka-shi (JP)

(73) Assignee: Koito Manufacturing Co., Ltd., Tokyo (JP)

(21) Appl. No.: 13/959,892

(22) Filed: Aug. 6, 2013

(30) Foreign Application Priority Data
Aug. 10, 2012 (JP) 2012179008

(51) Int. Cl. F21S 8/10; F21V 7/00

(52) U.S. Cl. CPC F21S 48/00; F21V 7/0033
USPC 362/516

(57) ABSTRACT

A front surface of a translucent member is shaped so that each light ray from a light-emitting portion is incident on the front surface at a predetermined incident angle θ equal to or larger than a critical angle β, and a rear surface of the translucent member (rotating body type) is designed in shape so that in a rear peripheral surface portion of the rear surface, a tilt angle α is “α<90°−2α−γ” when reflected light from the front surface of the translucent member is incident on the rear peripheral surface portion at the tilt angle α with respect to a vertical direction, where β represents the critical angle, and γ represents a shift angle of re-reflected light with respect to a horizontal direction. This allows the front surface and the rear surface of the translucent member to internally reflect light by total reflection without using a vapor-deposited film.

### CROSS-REFERENCE TO RELATED APPLICATIONS(S)

This application claims the benefit of priority of Japanese Patent Application No. 2012.179008 filed on Aug. 10, 2012, the contents of which are incorporated by herein in their entirety.

### TECHNICAL FIELD

The present disclosure relates to vehicular illumination lamps capable of enhancing productivity.

### RELATED ART

As described in Japanese Patent Application Laid-Open (Kokai) No. 2009-224303, a vehicular illumination lamp is proposed which includes a translucent member and a light source that causes light rays to be incident on the translucent member from the rear side of the translucent member. The front surface of the translucent member is formed so as to reflect incident light to produce reflected light, where incident light includes each light ray from the light source that is incident on the front surface of the translucent member. The rear surface of the translucent member is formed so as to receive the reflected light as incident light, to reflect the reflected light as re-reflected light, and to emit the re-reflected light to the front of the translucent member.

Specifically, in this vehicular illumination lamp, a part of the front surface of the translucent member is subjected to a vapor deposition (i.e., a mirror finish) in order to internally reflect the right rays from the light source, and most of the rear surface of the translucent member is subjected to a vapor deposition (i.e., a mirror finish) in order to internally reflect the reflected light from the front surface of the translucent member. With this structure, each light ray from the light source is emitted to the front of the translucent member by using the internal reflection at the front and rear surfaces of the translucent member.

### PROBLEM TO BE SOLVED BY THE INVENTION

In the foregoing vehicular illumination lamp, the front and rear surfaces of the translucent member need to be subjected to the vapor deposition. This requires a special facility for the vapor deposition, and additionally requires a special process using the special facility.

### SUMMARY

The present invention was developed in view of the problem of the related art, and it is an object of the present invention to provide a vehicular illumination lamp can be manufactured more easily, in order to enhance productivity.

In order to achieve the above object, according to an aspect of the present invention, a vehicular illumination lamp includes: a translucent member; and a light source that causes light rays to be incident on the translucent member from a rear side of the translucent member, wherein a front surface of the translucent member is formed so as to reflect incident light to produce reflected light when the light rays from the light source are incident on the front surface of the translucent member as the incident light, and a rear surface of the translucent member is formed so as to receive the reflected light as incident light and is formed so as to reflect the reflected light to a front of the translucent member as re-reflected light, and at least one of the front surface and the rear surface of the translucent member is shaped so as to totally reflect the incident light on the at least one of the front surface and the rear surface of the translucent member in an entire region capable of receiving the incident light. Preferred modes of claim 1 are as described in claim 2 and the subsequent claims.

According to some implementations, at least one of the front surface and the rear surface of the translucent member is shaped so as to totally reflect the incident light on the at least one of the front surface and the rear surface of the translucent member in the entire region capable of receiving the incident light. Thus, internal reflection can be caused by the total reflection without using a vapor-deposited film. This can reduce the number of locations that need be subjected to a vapor deposition as compared to conventional examples. Accordingly, the vehicular illumination lamp can be manufactured more easily, and can enhance productivity.

In some implementations, each of the front surface and the rear surface of the translucent member is shaped so as to totally reflect the incident light on that surface in the entire region capable of receiving the incident light in that surface. Thus, internal reflection can be caused by the total reflection at the front and rear surfaces of the translucent member without using a vapor-deposited film, and no vapor deposition need be performed on any location in order to cause internal reflection. This can further reduce the complexity of the vehicular lamp, and can further enhance productivity.

In some implementations, the front surface of the translucent member is shaped so that the light rays from the light source are incident on the front surface at a predetermined incident angle equal to or larger than a critical angle in the entire region capable of receiving the incident light in the front surface, and the rear surface of the translucent member is designed in shape so that at least in a vertical cross section including the light source, a tilt angle α is “α<90°−2β−γ” when the reflected light from the front surface of the translucent member is incident on the rear surface of the translucent member at the tilt angle α with respect to a vertical direction, where β represents the critical angle, and γ represents a shift angle of the re-reflected light with respect to a horizontal direction. Thus, internal reflection can be specifically caused by the total reflection at the front and rear surfaces of the translucent member, and no vapor deposition need be specifically performed on any location on the front and rear surfaces of the translucent member in order to cause internal reflection.

In this case, “90°” is included as a reference value (i.e., a maximum value) in the conditional expression “α<90°−2β−γ” because a balanced equation can be formed by including α, 2β, and γ within the angular range of 90° with respect to the direction in which light is emitted from the translucent member (i.e., the horizontal direction). This is condition expression, α is the tilt angle of the reflected light from the front surface of the translucent member with respect to the vertical direction, 2β is the angle that causes total reflection, and γ is the shift angle (i.e., the refraction angle) of the re-reflected light with respect to the direction in which the re-reflected light is emitted to the outside of the translucent member (i.e., the horizontal direction). The term “−2β refers to the sum of the incident angle and the reflection angle when the total reflection occurs, and has been included in order to account for conditions where total reflection occurs. The term “−γ” is included because the shift angle (refraction angle) of the re-reflected light, with respect to the direction in which the re-reflected light is emitted to the outside of the translucent member, needs to be added if the direction in which the re-reflected light is emitted to the outside of the translucent member is the horizontal direction.

In some implementations, the front surface of the translucent member is shaped so as to totally reflect the light rays from the light source in the entire region capable of receiving the incident light in the front surface. Thus, internal reflection can be specifically caused by the total reflection at the front surface of the translucent member, and no vapor deposition need be performed on any location on the front surface of the translucent member in order to cause internal reflection.

In some implementations, the front surface of the translucent member is designed in shape so that the light rays from the light source are incident on the front surface of the translucent member at a predetermined incident angle equal to or larger than a critical angle in the entire region capable of receiving the incident light in the front surface. Thus, the light rays from the light source can be specifically totally reflected by the front surface of the translucent member, and no vapor deposition need be specifically performed on any location on the front surface of the translucent member in order to cause internal reflection.

In some implementations, the rear surface of the translucent member is shaped so as to totally reflect the reflected light from the front surface of the translucent member in the entire region capable of receiving the incident light in the rear surface. Thus, the re-reflected light can be emitted to the front of the translucent member by total reflection at the rear surface of the translucent member, and no vapor deposition need be performed on any location on the rear surface of the translucent member in order to cause internal reflection.

In some implementations, the rear surface of the translucent member is designed in shape so that, at least in a vertical cross section including the light source, a tilt angle α is “α<90°−2β−γ” when the reflected light from the front surface of the translucent member is incident on the rear surface of the translucent member at the tilt angle α with respect to a vertical direction, where β represents a critical angle, and γ represents a shift angle of the re-reflected light with respect to a horizontal direction. Thus, internal reflection can be specifically caused by the total reflection at the rear surface of the translucent member, and no vapor deposition need be specifically performed on any location on the rear surface of the translucent member in order to cause internal reflection.

Other aspects, features and advantages will be readily apparent from the following detailed description, the accompanying the claims.

### BRIEF DESCRIPTION OF THE DRAWINGS

FIG. 1 is a vertical sectional view showing a vehicular illumination lamp according to a first embodiment.

FIG. 2 is a front view showing a translucent member of the vehicular illumination lamp according to the first embodiment.

FIG. 3 is an illustration illustrating an arrangement of LEDs with respect to the translucent member according to the first embodiment.

FIG. 4 is an illustration illustrating the effects of a front surface of the translucent member on incident light according to the first embodiment.

FIG. 5 is an illustration illustrating the effects of incident light on a rear peripheral surface portion (rear surface) of the translucent member according to the first embodiment.

FIG. 6 is an illustration illustrating the effects of right rays on a translucent member according to a second embodiment.

FIG. 7 is a front view of FIG. 6.

FIG. 8 is a top view of FIG. 6.

FIG. 9 is a side view of FIG. 6.

FIG. 10 shows a computer graphics image of a front surface and a rear peripheral portion of the translucent member according to the second embodiment as viewed from the top.

FIG. 11 shows a computer graphics image of the front surface and the rear peripheral portion of the translucent member according to the second embodiment as viewed from the rear.

FIG. 12 shows a computer graphics image of the front surface and the rear peripheral portion of the translucent member according to the second embodiment as viewed from the side.

FIG. 13 shows a computer graphics image of the front surface and the rear peripheral portion of the translucent member according to the second embodiment as viewed from the front.

### BEST MODE FOR CARRYING OUT THE INVENTION

Examples of the present invention are described below with reference to the accompanying drawings.

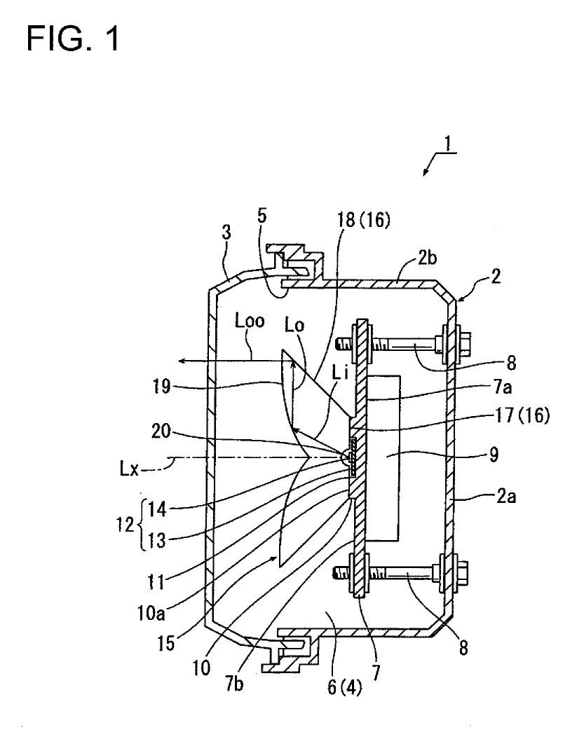

In FIG. 1, reference numeral 1 denotes a vehicular illumination lamp according to a first embodiment. The exterior of the vehicular illumination lamp 1 is formed by a lamp body 2 opening at its front, and a front cover 3 covering the opening of the lamp body 2. The lamp body 2 is formed by a back wall portion 2a standing in the vertical direction, and a peripheral wall portion 2b protruding forward from the peripheral edge of the back wall portion 2a. The back wall portion 2a and the peripheral wall portion 2b define an accommodating space 4, and the tip end of the peripheral wall portion 2b defines an opening 5 that opens the accommodating space 4 to the outside. The front cover 3 is detachably attached the tip end of the peripheral wall portion 2b of the lamp body 2. The front cover 3 is made of a translucent material, and the front cover 3 and the lamp body 2 form a sealed space 6.

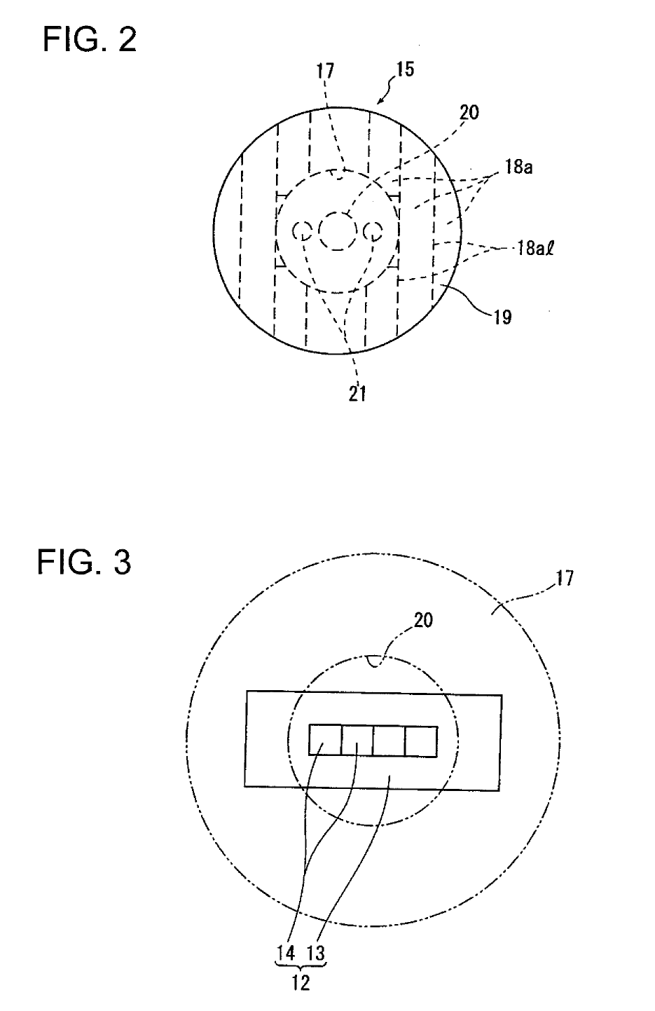

As shown in FIG. 1, a plate-like support member 7 made of a metal (e.g., an aluminum die cast product) 7 is disposed in the sealed space 6. The support member 7 is supported by the back wall portion 2a of the lamp body 2 via a plurality of aiming screws 8, and is placed such that the plate surface of the support member 7 faces the longitudinal direction and is separated forward from the back wall portion 2a by a fixed distance. A rear surface 7a (the right surface in FIG. 1) of the support member 7 as a flat surface faces the back wall portion 2a of the lamp body 2, and a heat dissipating fin 9 that dissipates heat is attached to the rear surface 7a. A translucent-member attaching portion 10 is formed on the central part of a front surface 7b (the left surface in FIG. 1) of the support member 7, where the central part refers to the central part in both the lateral direction (e.g., the lateral direction in FIG. 2) and the vertical direction (e.g., the vertical direction in FIG. 1). The translucent-member attaching portion 10 is formed by making the support member 7 thicker than the remaining part of the support member 7. A front surface 10a of the translucent-member attaching portion 10 as a flat surface faces forward. A horizontally long recess 11 is formed in the central part of the front surface 10a of the translucent-member attaching portion 10, and a light-emitting portion 12 forming a light source is held in the recess 11. The light-emitting portion 12 is formed by an LED substrate 13 having a horizontally long shape corresponding to the recess 11 and being held in the recess 11, and a plurality of LEDs (in the present embodiment, white LEDs) 14 arranged on the surface of the LED substrate 13. As shown in FIG. 3, the plurality of LEDs 14 are arranged side by side in the direction in which the LED substrate 13 extends. Specifically, four 1-mm square LEDs 14 are arranged side by side in the lateral direction. A horizontally long orientation pattern can be obtained based on this horizontally long arrangement of the LEDs 14.

As shown in FIG. 1, a translucent member 15 is of a rotating body type, and is attached to the front surface 10a of the translucent-member attaching portion 10. A rear surface 16 of the translucent member 15 includes a circular central surface portion 17 and a rear peripheral surface portion 18 whose diameter is increased as it extends from the outer edge of the central surface portion 17 forward. A front surface 19 of the translucent member 15 extends rearward in a gradually curved manner from the tip end of the rear peripheral surface portion 18 in the radially inward direction. The central surface portion 17 of the rear surface 16 of the translucent member is attached to the translucent-member attaching portion 10 of the support member 7. The translucent member 15 is thus disposed so that its front surface 19 is located forward of its rear surface 16 and faces the front cover 3. A hemispherical accommodating hole 20 is formed in the central surface portion 17 of the translucent member 15. With the central surface portion 17 being attached to the translucent-member attaching portion 10, the plurality of LEDs 14 are accommodated in the accommodating hole 20. Thus, light rays from the plurality of LEDs 14 are incident on the translucent member 15 from the central surface portion 17 (i.e., the rear side) of the translucent member 15 through the accommodating hole 20. In FIG. 2, reference numeral 21 denotes a screw hole that fastens the translucent member 15 to the support member 7. The rearmost part of the front surface 19 of the translucent member 15 is positioned on an optical axis Lx, and the LEDs 14 are also arranged on this optical axis Lx.

The entire front surface 19 of the translucent member 15, which is formed as a rotating body type, serves as a region capable of receiving incident light from the light-emitting portion 12. The front surface 19 is formed so as to totally reflect light rays Li from the light-emitting portion 12 to produce reflected light Lo. Specifically, the front surface 19 is formed so that each light ray Li from the LEDs 14 is incident on the front surface 19 at a predetermined incident angle equal to or larger than a critical angle. When each light ray from the light-emitting portion 12 is incident on the front surface 19 of the translucent member 15 as incident light, each light ray Li is totally reflected, and the reflected light Lo travels substantially outward in the radial direction of the translucent member 15 (see FIG. 1).

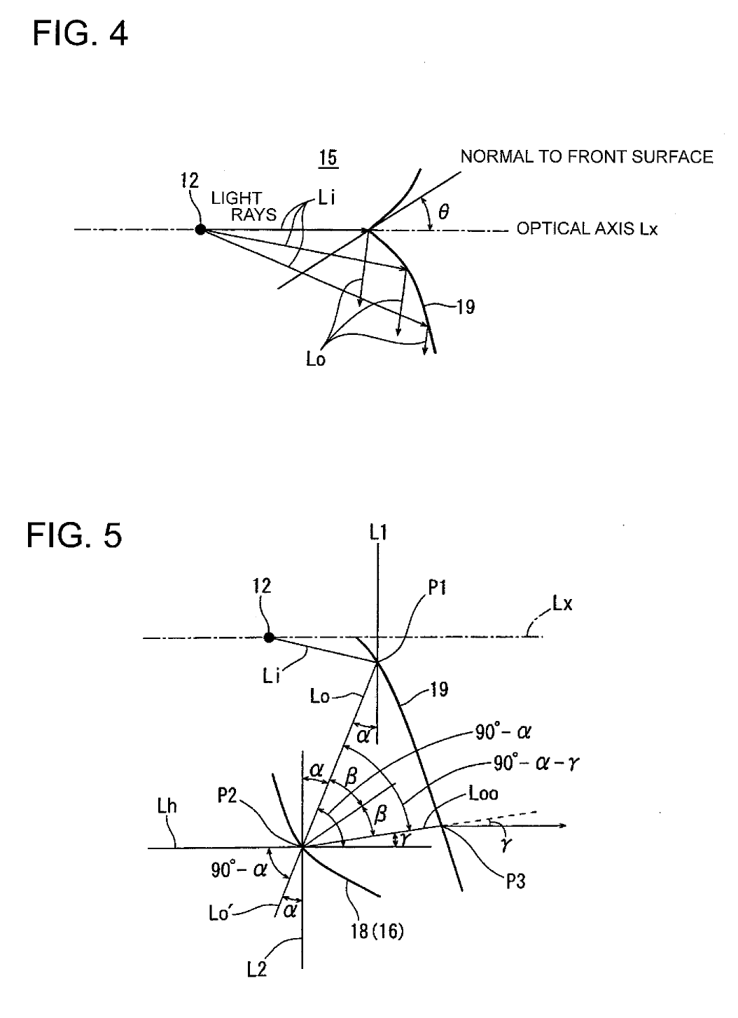

More specifically, as shown in FIG. 4, the reflection direction of the reflected light (i.e., the totally reflected light) Lo is determined by whether the light ray (i.e., the incident light) Li from the light-emitting portion 12 is incident on the upper side or the lower side of the front surface 19 of the translucent member with respect to the optical axis Lx. If the light ray Li from the light-emitting portion 12 is incident on the upper side of the front surface 19 of the translucent member with respect to the optical axis Lx, the reflected light Lo is reflected outward in the radial direction of the translucent member 15 in the area located above the optical axis Lx. If the light ray Li is incident on the lower side of the front surface 19 of the translucent member with respect to the optical axis Lx, the reflected light Lo is reflected outward in the radial direction of the translucent member 15 in the area located below the optical axis Lx (see FIG. 4). In this case, as the light ray Li is located farther away from the optical axis Lx, the light ray Li is incident on the front surface 19 of the translucent member at a larger incident angle θ and critical conditions are more likely to be satisfied. In addition, the angle between a normal to the front surface 19 of the translucent member and the optical axis Lx can be reduced.

Of the rear surface 16 of the translucent member 15, the entire rear peripheral surface portion 18 is formed as a rotating body type, and due to its shape described above, serves as a region capable of receiving the reflected light Lo from the front surface 19 of the translucent member. The rear peripheral surface portion 18 is designed so that all of the reflected light Lo from the front surface 19 of the translucent member is incident on the rear peripheral surface portion 18 of the rear surface 16 of the translucent member. The rear peripheral surface portion 18 of the rear surface 16 of the translucent member is shaped so as to totally reflect the reflected light Lo from the front surface 19 of the translucent member to produce re-reflected light Loo. Specifically, as shown in FIG. 2, the rear peripheral surface portion 18 of the rear surface 16 of the translucent member is formed by a plurality of segments (i.e., portions) 18a. As shown in FIG. 5, each segment 18a (dashed line 18a1 in FIG. 2 represents a segment line on the rear surface 16) is designed so that a tilt angle α is “α<90°−2β−γ” when the reflected light Lo from the front surface 19 of the translucent member is incident on the rear peripheral surface portion 18 of the rear surface 16 of the translucent member at the tilt angle α with respect to the vertical direction, where β represents a critical angle, and γ represents a shift angle (i.e. a refraction angle) of the re-reflected light Loo with respect to the horizontal direction.

This will be described in detail with reference to FIG. 5. P1 represents a reflection point of the light ray (i.e., the incident light) Li from the light-emitting portion 12 on the front surface 19 of the translucent member, P2 represents a reflection point of the reflected light Lo on the rear surface 16 of the translucent member (each segment 18a of the rear peripheral surface portion 18), L1 and L2 represent vertical lines extending through P1 and P2, respectively, and a represents a tilt angle formed by the vertical line L1 and the reflected light Lo. In this case, the angle formed by the vertical line L2 and an extended line Lo′ of the reflected light Lo from the front surface 19 of the translucent member is also α, as the tilt angle and this angle are corresponding angles. Since a horizontal line Lh (which extends in the direction in which light is emitted and extends through the re-reflection point P2 on the rear surface 16 of the translucent member) and the vertical line L2 form an angle of 90°, the angle formed by the horizontal line Lb and the extended line Lo′ of the reflected light Lo is “90°−α,” and its vertically opposite angle formed by the horizontal line Lh and the reflected light Lo is “90°−α.” In this case, in order for the reflected light Lo to be totally reflected by the rear surface 16 of the translucent member and for the re-reflected light Loo to be emitted forward from the front surface 19 of the translucent member in the horizontal direction, an angle for total reflection (i.e., angle 2β, which is twice the critical angle β provided that the incident angle and the reflection angle are equal to the critical angle β needs to be within the angular range of “90°−α−γ,” in view of the fixed shift angle (i.e., the refraction angle) γ with respect to the direction in which light is emitted from the front surface 19 of the translucent member (i.e., the horizontal direction). In FIG. 5, P3 represents an incident point of the re-reflected light Loo on the front surface 19 of the translucent member. “90°−α−γ” needs to satisfy the conditional expression of “90°−α−γ>2β.” Thus, in the present embodiment, the tilt angle α formed by the vertical line L1 and the reflected light Lo at the front surface 19 of the translucent member is adjusted to cause total reflection at the front surface 19 of the translucent member (where the incident angle θ is equal to or larger than the critical angle), and to satisfy the above conditional expression, in order to cause total reflection at both the front surface 19 and the rear surface 16 of the translucent member 15.

It should be understood that in order to cause total reflection only at the rear surface 16 of the translucent member and not at the front surface 19 of the translucent member, the angle α need not be such an angle that causes total reflection at the front surface 19 of the translucent member, and need only satisfy the above conditional expression.

In such a vehicular illumination lamp 1, as shown in FIG. 1, each light ray Li from the light-emitting portion 12 is totally reflected by the front surface 19 of the translucent member, and the reflected light (i.e., the totally reflected light) Lo travels to the rear peripheral surface portion 18 of the rear surface 16 of the translucent member. Then, the reflected light Lo is totally reflected by the rear peripheral surface portion 18 of the rear surface 16 of the translucent member, and the re-reflected light Loo passes through the front surface 19 of the translucent member and the front cover 3, and is emitted to the front of the vehicular illumination lamp 1.

Accordingly, when emitting light to the front of such a vehicular illumination lamp 1, light can be internally reflected by the front surface 19 and the rear surface 16 of the translucent member 15 by total reflection without using a vapor-deposited film. Thus, no vapor deposition need be performed on any location in order to cause internal reflection. This eliminates the need for a special facility for the vapor deposition, and thus eliminates the need for a special process using the special facility. As such, the vehicular illumination lamp 1 is easier to manufacture, and can enhance productivity.

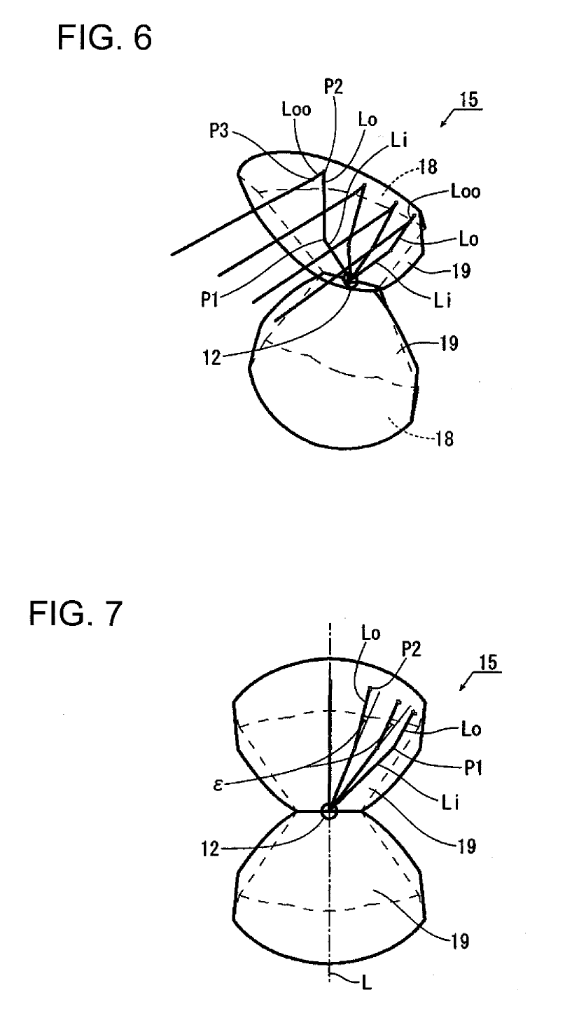

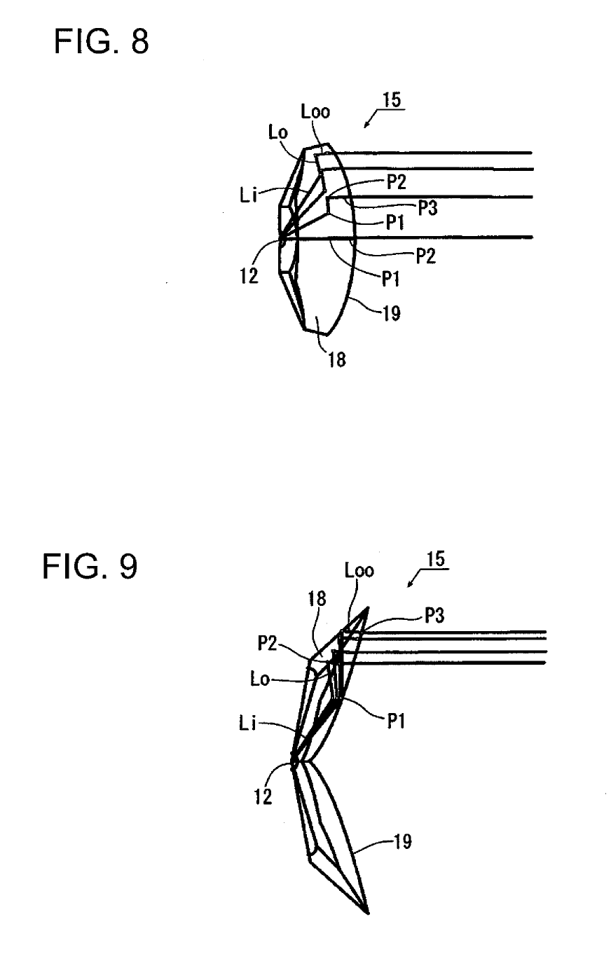

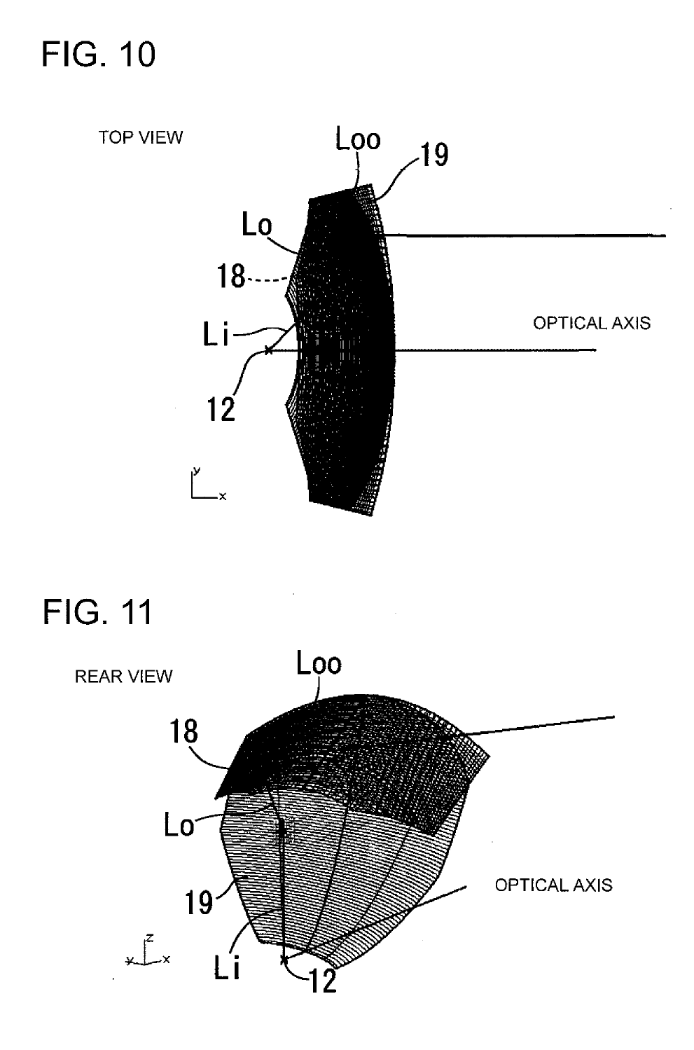

FIGS. 6 to 9 (and FIGS. 10 to 13 described later) show a second embodiment. In the second embodiment, the same components as those of the first embodiment are denoted with the same reference characters, and description thereof will be omitted.

The second embodiment shows a vehicular illumination lamp in which the front surface 19 of the translucent member 15 is formed as a non-rotating body. The front surface 19 of the translucent member 15 is formed as a non-rotating body because forming the front surface 19 of the translucent member as a rotating body may create an impression that the vehicular illumination lamp has a round design, which may be undesirable in certain circumstances.

As in the first embodiment, in such a translucent member 15 as well, the front surface 19 is formed so that the incident angle of each light ray Li from the LEDs 14 is a predetermined angle equal to or larger than the critical angle. Each light ray Li is thus totally reflected, and the reflected light Lo travels substantially outward in the radial direction of the translucent member 15. However, since the front surface 19 is formed as a non-rotating body, the front surface 19 reflects each light ray Li so that the reflected light Lo is bent toward a vertical cross section (shown by chain line) L, extending through the light-emitting portion 12, with respect to each light ray Li as viewed from the front (FIG. 7). The bend angle ε of each reflected light ray Lo increases as the reflected light ray Lo is located farther away from the vertical cross section L (in FIG. 7, located farther away from the vertical cross section L in the lateral direction).

It should be understood that such reflected light (i.e. totally reflected light) Lo from the front surface 19 also subsequently travels toward the rear peripheral surface portion 18 of the rear surface 16 of the translucent member, and is totally reflected by the rear peripheral surface portion 18. The re-reflected light Loo passes through the front surface 19 of the translucent member and the front cover 3 and is emitted to the front of the vehicular illumination lamp 1.

In this example, the rear surface 16 of the translucent member can be formed not only as a rotating body but also as a non-rotating body. In that case, the rear surface 16 of the translucent member is shaped so as to be located farther away from the rear surface 16 of the translucent member formed as a rotating body as the bend angle of the reflected light Lo described above increases. Each light ray Li from the LEDs 14 is emitted toward the front of the translucent member 15 by such a rear peripheral surface portion 18 and the front surface 19 of the translucent member.

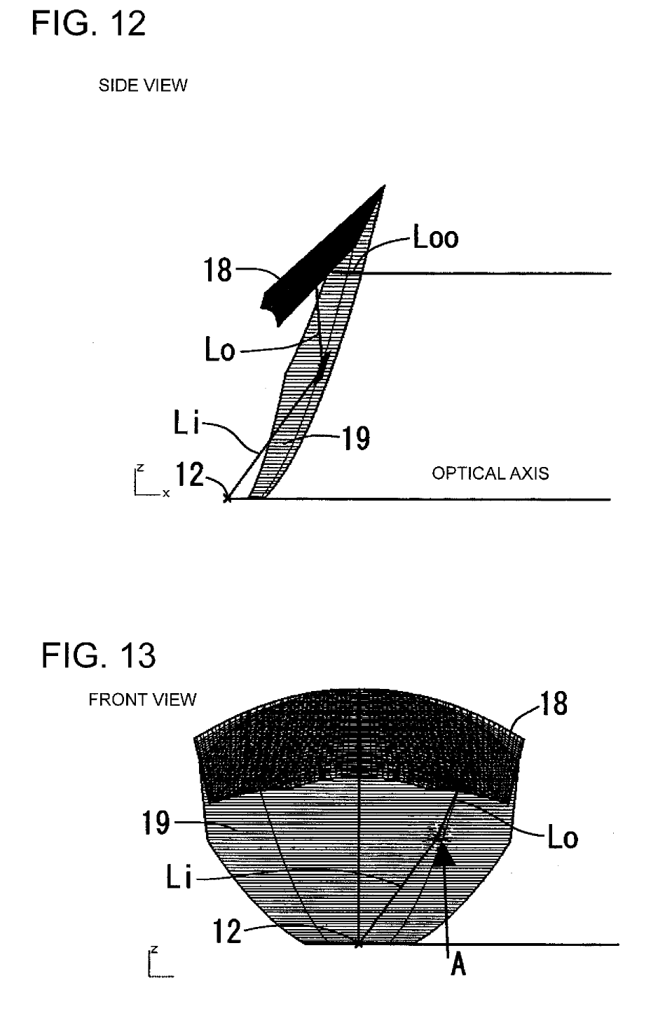

FIGS. 10 to 13 show computer graphics images of the configuration in FIGS. 6 to 9 in order to more specifically show the configuration. FIG. 10 is a top view, FIG. 11 is a rear view, FIG. 12 is a side view, and FIG. 13 is a front view. Each figure shows only the upper half, and the lower half is symmetrical with the upper half. In this case, a portion A in FIG. 13 shows that the reflected light Lo from the front surface 19 of the translucent member is bent as viewed from the front, because the front surface 19 of the translucent member is formed as a non-rotating body.

Although various embodiments are described above, the present disclosure describes the following features applicable in some implementations.

(1) Instead of totally reflecting light from both the front surface 19 and the rear peripheral surface portion 18 of the translucent member 15, light is totally reflected only by one of them, namely the front surface 19 of the translucent member, and the reflected light from the front surface 19 of the translucent member is reflected again by the rear peripheral surface portion 18 of the translucent member 15 by using a vapor-deposited film. This can enhance the productivity of the vehicular illumination lamp as compared to the case where a vapor-deposited film is used in both the front surface 19 and the rear surface 16 of the translucent member 15.

(2) Instead of totally reflecting light from both the front surface 19 and the rear peripheral surface portion 18 of the translucent member 15, light is totally reflected only by one of them, namely the rear peripheral surface portion 18 of the translucent member 15, and the reflected light from the front surface 19 of the translucent member is reflected again by the front surface 19 of the translucent member 15 by using a vapor-deposited film. This can also enhance the productivity of the vehicular illumination lamp as compared to the case where a vapor-deposited film is used in both the front surface 19 and the rear surface 16 of the translucent member 15.

In this case, the angle α formed by the vertical line L1 and the reflected light at the front surface 19 of the translucent member need not be such an angle that causes total reflection from the front surface 19 of the translucent member, and need only satisfy the conditional expression “90°−α−γ21 2β” at least in a vertical cross section including the light source in the rear peripheral surface portion 18.

Other implementations are within the scope of the claims.

### DESCRIPTION OF THE REFERENCE NUMERALS

1 VEHICULAR ILLUMINATION LAMP
12 LIGHT-EMITTING PORTION (LIGHT SOURCE)
14 LED
15 TRANSLUCENT MEMBER
16 REAR SURFACE OF TRANSLUCENT MEMBER
18 REAR PERIPHERAL SURFACE PORTION OF REAR SURFACE
19 FRONT SURFACE OF TRANSLUCENT MEMBER
Li LIGHT RAY FROM LIGHT-EMITTING PORTION (INCIDENT LIGHT)
Lo REFLECTED LIGHT
Loo RE-REFLECTED LIGHT
β CRITICAL ANGLE
γ SHIFT ANGLE WITH RESPECT TO HORIZONTAL DIRECTION (REFRACTION ANGLE)

What is claimed is:

1. A vehicular illumination lamp comprising:
a translucent member; and
a light source that causes light rays to be incident on the translucent member from a rear side of the translucent member, wherein
a front surface of the translucent member is formed so as to reflect incident light to produce reflected light when the light rays from the light source are incident on the front surface of the translucent member as the incident light, and a rear surface of the translucent member is formed so as to receive the reflected light as incident light and is formed so as to reflect the reflected light to a front of the translucent member as re-reflected light, and
at least one of the front surface and the rear surface of the translucent member is shaped so as to totally reflect the incident light on the at least one of the front surface and the rear surface of the translucent member in an entire region capable of receiving the incident light.

2. The vehicular illumination lamp according to claim 1, wherein
each of the front surface and the rear surface of the translucent member is shaped so as to totally reflect the incident light on that surface in the entire region capable of receiving the incident light in that surface.

3. The vehicular illumination lamp according to claim 2, wherein
the front surface of the translucent member is shaped so that the light rays from the light source are incident on the front surface at a predetermined incident angle equal to or larger than a critical angle in the entire region capable of receiving the incident light in the front surface, and
the rear surface of the translucent member is designed in shape so that at least in a vertical cross section including the light source, a tilt angle α is “α<90°−2β−γ” when the reflected light from the front surface of the translucent member is incident on the rear surface of the translucent member at the tilt angle α with respect to a vertical direction, where β represents the critical angle, and γ represents a shift angle of the re-reflected light with respect to a horizontal direction.

4. The vehicular illumination lamp according to claim 1, wherein
the front surface of the translucent member is shaped so as to totally reflect the light rays from the light source in the entire region capable of receiving the incident light in the front surface.

5. The vehicular illumination lamp according to claim 4, wherein
the front surface of the translucent member is designed in shape so that the light rays from the light source are incident on the front surface of the translucent member at a predetermined incident angle equal to or larger than a critical angle in the entire region capable of receiving the incident light in the front surface.

6. The vehicular illumination lamp according to claim 1, wherein
the rear surface of the translucent member is shaped so as to totally reflect the reflected light from the front surface of the translucent member in the entire region capable of receiving the incident light in the rear surface.

7. The vehicular illumination lamp according to claim 6, wherein
the rear surface of the translucent member is designed in shape so that at least in a vertical cross section including the light source, a tilt angle α is “α<90°−2β−γ” when the reflected light from the front surface of the translucent member is incident on the rear surface of the translucent member at the tilt angle α with respect to a vertical direction, where β represents a critical angle, and γ represents a shift angle of the re-reflected light with respect to a horizontal direction.
